(19) United States
(12) Patent Application Publication
(10) Pub. No.: US 2022/0164718 A1
(43) Pub. Date: May 26, 2022

(54) ALLOCATED VEHICLE EXTRACTION SERVER, ALLOCATED VEHICLE EXTRACTION MEANS, ALLOCATED VEHICLE EXTRACTION METHOD, AND ALLOCATED VEHICLE DISPLAY TERMINAL

(71) Applicant: Nissan Motor Co., Ltd., Kanagawa (JP)

(72) Inventor: Tatsuyuki Nakajima, Kanagawa (JP)

(73) Assignee: Nissan Motor Co., Ltd., Kanagawa (JP)

(21) Appl. No.: 17/601,015

(22) PCT Filed: Apr. 2, 2019
(86) PCT No.: PCT/IB2019/000372

§ 371 Date: Oct. 1, 2021

(51) Int. Cl. G06Q 10/02; G01C 21/34

(52) U.S. Cl. CPC G06Q 10/02; G01C 21/3407

(57) ABSTRACT

An allocated vehicle extraction server, an allocated vehicle extraction means, an allocated vehicle extraction method, and/or an allocated vehicle display terminal calculate a travel time of a user from a user position to the waiting point at which the user waits for the allocated vehicle and a waiting time of the user obtained by subtracting the travel time of the user from a time from making the vehicle allocation request by the user to getting on the allocated vehicle, and extract the allocated vehicle based on the travel time and the waiting time.

### TECHNICAL FIELD

The present invention relates to an allocated vehicle extraction server, an allocated vehicle extraction means, an allocated vehicle extraction method, and an allocated vehicle display terminal.

### BACKGROUND ART

Patent Literature 1 proposes a system for calling an allocated vehicle selected by a user. The system can call the allocated vehicle by displaying, on the user terminal, information of the allocated vehicle located within a predetermined range from the user's position and then by the user by performing an operation for calling the allocated vehicle.

### CITATION LIST

### Patent Literature

Patent Literature 1: Japanese Patent Laid-Open Publication No. 2013-134641

### SUMMARY OF INVENTION

### Technical Problem

However, the technique described in Patent Literature 1 uniformly displays the allocated vehicle within the predetermined range from the user's position when displaying the allocated vehicle on the user terminal. Therefore, for example, a case that the user himself/herself moves is not taken into consideration, or a waiting time until the user gets on the allocated vehicle is not taken into consideration, and an inappropriate allocated vehicle may be displayed depending on the user.

The present invention has been made in view of the problem described above, and an object of the present invention is to provide an allocated vehicle extraction server, an allocated vehicle extraction means, an allocated vehicle extraction method, and/or an allocated vehicle display terminal that enable improving convenience for users of vehicle allocation systems based on the movement of the user himself/herself and the waiting time for the user to get on the allocated vehicle.

### Solution to Problem

In order to solve the above problems, an allocated vehicle extraction server, an allocated vehicle extraction means, an allocated vehicle extraction method, and/or an allocated vehicle display terminal according to an aspect of the present invention calculate a travel time of a user from a user position to the waiting point at which the user waits for the allocated vehicle, and a waiting time of the user obtained by subtracting the travel time of the user from a time from making the vehicle allocation request by the user to getting on the allocated vehicle, and extract the allocated vehicle based on the travel time and the waiting time.

### Advantageous Effects of Invention

According to the present invention, it is possible to improve convenience for users of vehicle allocation systems based on the movement of the user himself/herself and the waiting time for the user to get on the allocated vehicle.

### BRIEF DESCRIPTION OF DRAWINGS

FIG. 1 is a block diagram illustrating a configuration of a vehicle allocation system including an allocated vehicle extraction server and an allocated vehicle display terminal according to an embodiment of the present invention.

FIG. 2 is a graph showing user characteristic of a user using the vehicle allocation system.

FIG. 3A is a diagram showing an example of a user position, a position of an allocated vehicle, and a waiting point.

FIG. 3B is a graph showing a pair of a travel time of the user and a waiting time of the user, calculated in a positional relationship shown in FIG. 3A, the pair plotted in a graph showing the user characteristic.

FIG. 4 is a flowchart illustrating a process procedure of an allocated vehicle extraction according to the embodiment of the present invention.

### DESCRIPTION OF EMBODIMENTS

Embodiments of the present invention will be described below in detail with reference to the accompanying drawings. In the following descriptions, like elements are denoted by like reference signs and redundant descriptions thereof will be omitted.

### [Configuration of Vehicle Allocation System]

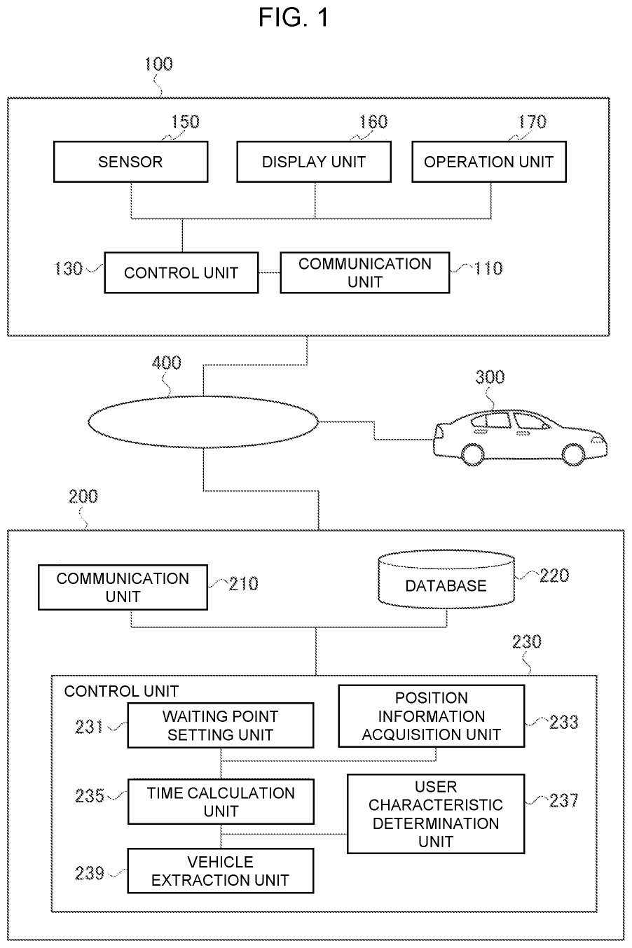

FIG. 1 is a block diagram illustrating a configuration of a vehicle allocation system including an allocated vehicle extraction server and an allocated vehicle display terminal according to an embodiment of the present invention. As shown in FIG. 1, the vehicle allocation system includes an allocated vehicle display terminal 100 (operation terminal), an allocated vehicle extraction server 200, an allocated vehicle 300, which are connected to each other by a wireless or wired network 400.

The allocated vehicle display terminal 100 receives a vehicle allocation request from the user and transmits the received vehicle allocation request. Examples of the allocated vehicle display terminal 100 include mobile terminals (smartphones, tablets, etc.) that users use on a daily basis.

The allocated vehicle extraction server 200 acquires the vehicle allocation request of the user and information of the allocated vehicle 300, and extracts a combination (recommended combination) of a waiting point and the allocated vehicle 300 according to the vehicle allocation request, based on the acquired information. Then, information of the combination of the waiting point and the allocated vehicle 300 is output. The recommended combination is a combination of the recommended waiting point and the recommended allocated vehicle, extracted from the combination of the waiting point and the allocated vehicle 300.

The waiting point is a place where the user can get in and/or out of the allocated vehicle 300 by stopping the allocated vehicle 300 and is a point on the map data registered in advance in the vehicle allocation system. The allocated vehicle 300 is a vehicle that provides a means of moving to a destination designated by the user (destination of the user), and includes, for example, a self-driving vehicle. Other examples of the allocated vehicle 300 include various means of transportation such as manned/unmanned taxis, buses, and trucks. In the vehicle allocation system, a plurality of waiting points and a plurality of allocated vehicles are registered.

The network 400 includes, for example, the Internet. The network 400 may use a mobile communication function such as 4G/LTE or 5G.

Although not shown in FIG. 1, a management server of a servicer (for example, a vehicle allocation service provider such as DeNA (registered trademark) or UBER (registered trademark)) may form a part of the vehicle allocation system by being connected to the network 400.

In this case, the vehicle allocation request transmitted from the allocated vehicle display terminal 100 may be processed by the servicer management server, and the vehicle allocation request after being processed may be transmitted to the allocated vehicle extraction server 200. Further, the information of the allocated vehicle 300 may be processed by the management server of the servicer, and the processed information of the allocated vehicle 300 may be transmitted to the allocated vehicle extraction server 200.

Further, information of the allocated vehicle 300 output from the allocated vehicle extraction server 200 may be processed by the management server of the servicer, and the processed information may be transmitted to the allocated vehicle display terminal 100.

In the following, for the sake of simplification of the explanation, it is assumed that the management server of the servicer is omitted, the allocated vehicle display terminal 100 can communicate bidirectionally with the allocated vehicle extraction server 200 via the network 400, and further, the allocated vehicle 300 can communicate bidirectionally with the allocated vehicle extraction server 200 via the network 400.

### [Configuration of Allocated Vehicle Display Terminal]

The allocated vehicle display terminal 100 is explained next. As shown in FIG. 1, the allocated vehicle display terminal 100 according to the present embodiment includes a sensor 150, a display unit 160, an operation unit 170, a communication unit 110, and a control unit 130 (controller).

The sensor 150 is composed of a plurality of sensor groups, and includes a position detection sensor that acquires the position information of the allocated vehicle display terminal 100. For example, the position detection sensor is a sensor that measures an absolute position such as GPS (Global Positioning System).

In addition, the sensor 150 may include an environmental sensor that acquires environmental information regarding the environment in which the allocated vehicle display terminal 100 is placed. For example, environmental sensors include a temperature sensor, a humidity sensor, a vibration sensor, an acceleration sensor, a microphone, and the like.

The display unit 160 displays information of the allocated vehicle 300 provided by the vehicle allocation system and information of the waiting point where the user meets with the allocated vehicle 300. The information of the allocated vehicle 300 and the information of the waiting point are acquired from the allocated vehicle extraction server 200 via the network 400 by the communication unit 110 described later. In addition, the display unit 160 may display route information necessary for heading to the waiting point and guidance information for guiding the movement of the user to the waiting point.

The operation unit 170 receives the user's operation corresponding to various commands from the user to the vehicle allocation system. For example, the operation unit 170 may be an input interface having a plurality of buttons, or may be a touch panel having a touch interface.

More specifically, the display unit 160 may display an icon represented by a picture or a symbol so that the user can operate the icon, and the operation unit 170 may receive a user's operation when the user touches or drags the displayed icon.

The communication unit 110 transmits/receives information to/from the network 400. The communication unit 110 stores the information acquired from the network 400 in a memory or the like (not shown), and outputs predetermined information such as the vehicle allocation request and the environmental information to the network 400. For example, the communication unit 110 may be an in-vehicle device having a 4G/LTE mobile communication function, or may be an in-vehicle device having a Wi-Fi communication function.

The control unit 130 is connected to the sensor 150, the display unit 160, the operation unit 170, and the communication unit 110. Information from the sensor 150, the operation unit 170, and the communication unit 110 are input to the control unit 130. Information are output from the control unit 130 to the display unit 160 and the communication unit 110.

The control unit 130 is a general-purpose microcomputer including a CPU (central processing unit), a memory, and an input/output unit. A computer program (allocated vehicle display program) for functioning as a part of the allocated vehicle display terminal 100 is installed in the control unit 130. By executing the computer program, the control unit 130 controls the display unit 160 and the communication unit 110.

Various types of information processing included in the control unit 130 may be realized by software or may be realized by dedicated hardware.

As for the information processing performed by the control unit 130, in particular, the control unit 130 acquires the vehicle allocation request from the user based on the user's operation on the operation unit 170. For example, the vehicle allocation request may include the designation of the destination to which the user plans to go by using the allocated vehicle. In addition, the vehicle allocation request may include specifications such as the number of passengers, specifications, and types of the allocated vehicle.

In addition, the vehicle allocation request may include user attribute information. The user attribute information may include information such as the user's preference, age, gender, occupation, physical characteristics, presence/absence of an event before and after the vehicle allocation request, and event type. For example, when the allocated vehicle display terminal 100 is a mobile terminal (smartphone, tablet, etc.) that the user uses on a daily basis, the user attribute information may be acquired by the application as the allocated vehicle display program which links with SNS (social network service), a cloud service or the like.

### [Configuration of Allocated Vehicle Extraction Server]

The allocated vehicle extraction server 200 is explained next. As shown in FIG. 1, the allocated vehicle extraction server 200 according to the present embodiment includes a communication unit 210 (communication means), a database 220, and a control unit 230 (controller).

The communication unit 210 transmits/receives information to/from the network 400. The communication unit 210 acquires predetermined information such as the vehicle allocation request transmitted from the allocated vehicle display terminal 100 and vehicle information transmitted from the allocated vehicle 300 (For example, positional information of the allocated vehicle, information of remaining fuel amount, and status information indicating whether or not a vehicle allocation service is being provided) from the network 400, and records the acquired information in the database 220.

The database 220 stores the information acquired by the communication unit 210. In addition, the database 220 may store a user's past vehicle allocation request, usage history of the vehicle allocation system, frequency of the vehicle allocation request, and the like. In addition, the database 220 may store various parameter tables for estimating user characteristic of the user.

The control unit 230 (an example of a controller and a processing unit) is a general-purpose microcomputer including a CPU (central processing unit), a memory, and an input/output unit. A computer program (allocated vehicle extraction program) for functioning as a part of the allocated vehicle extraction server is installed in the control unit 230. By executing the computer program, the control unit 230 functions as a plurality of information processing circuits (231, 233, 235, 237, 239).

Here, an example is shown in which a plurality of information processing circuits (231, 233, 235, 237, 239) included in the control unit 230 are realized by software. However, it is also possible to configure an information processing circuit (231, 233, 235, 237, 239) by preparing dedicated hardware for executing each of the following information processing. Further, a plurality of information processing circuits (231, 233, 235, 237, 239) may be configured by individual hardware.

The control unit 230, as a plurality of information processing circuits (231, 233, 235, 237, 239), includes a waiting point setting unit 231, a position information acquisition unit 233, a time calculation unit 235, a user characteristic determination unit 237, and a vehicle extraction unit 239.

The position information acquisition unit 233 (position acquisition means) acquires a user position and a vehicle position of the allocated vehicle 300 at the time of the vehicle allocation request via the communication unit 210.

Based on the user position acquired by the position information acquisition unit 233, the waiting point setting unit 231 (waiting point setting means) selects a waiting point within a range of a predetermined distance from the user position from among waiting points registered in the vehicle allocation system as a calculation target by the time calculation unit 235. Based on the user position and the vehicle position of the allocated vehicle 300 acquired by the position information acquisition unit 233, the waiting point setting unit 231 selects an allocated vehicle within a range of a predetermined distance from the user position from among allocated vehicles registered in the vehicle allocation system as a calculation target by the time calculation unit 235.

The reason why the entire waiting points registered in the vehicle allocation system is not included in the calculation target is that it is not realistic for the user to move to the waiting point which is too far from the user position. In addition, the reason why the entire allocated vehicles registered in the vehicle allocation system is not included in the calculation target is that an allocated vehicle that is too far from the user position or the waiting point is assumed to take a long time to arrive at the waiting point, and thus, is not suitable for allocating to the user. Further, by limiting the calculation target, the total calculation cost can be reduced.

However, the present embodiments can be implemented even if the waiting point setting unit 231 covers the entire registered waiting points as the calculation target without limiting the calculation target.

The time calculation unit 235 (time calculation means) targets the waiting point and the allocated vehicle selected as the calculation target, calculates a travel time of the user from the user position to the waiting point, a waiting time of the user obtained by subtracting the travel time of the user from a time from making the vehicle allocation request by the user to getting on the allocated vehicle. The time calculation unit 235 calculates the travel time of the user, the waiting time of the user, and a total time of the user for each combination of the waiting point and the allocated vehicle. The travel time of the user is a time required when the user moves from the user position to the waiting point without stopping.

For example, it is assumed that one waiting point and one allocated vehicle selected from the calculation target. A case of calculation of the travel time of the user, the waiting time of the user, and a total time of the user, the calculation performed for a combination of one waiting point and one allocated vehicle selected from the calculation target is explained.

A time required for the allocated vehicle to move to the waiting point is defined as “vehicle side travel time TC”, and a time required for the user to move to the waiting point is defined as “user side travel time TP” (user travel time). The vehicle side travel time TC is calculated on the basis of the waiting point, the vehicle position of the allocated vehicle, the road conditions, the direction of the allocated vehicle with respect to the traveling direction of the road, and the like. The user side travel time TP is calculated based on the waiting point and the user position.

A maximum value function “Max (x, y)” is defined as a function which becomes “Max (x, y)=x” in the case of a magnitude relation “x≥y” and becomes “Max (x, y)=y” in the case of a magnitude relation “x<y”. Then, a time “pre-use time TS” from the vehicle allocation request to the time when the user gets on the allocated vehicle is calculated by the following equation (1).

TS=Max(TC,TP) (1)

In order to derive the equation (1), it is assumed that a time required for the user to get on the allocated vehicle after the user and the allocated vehicle meet at the waiting point is negligibly small compared with the vehicle side travel time TC and the user side travel time TP.

Therefore, the time for the user to wait, “user side waiting time TW” (waiting time of the user), is calculated by the following equation (2).

TW=TS−TP (2)

Therefore, the user side waiting time TW (user waiting time) can be calculated by determining the waiting point, the vehicle position of the allocated vehicle, and the user position.

In addition to the time when the user waits at the waiting point, the waiting time of the user includes the time when the user waits at the user position when the vehicle allocation request is made, and the user stops while moving from the user position to the waiting point, are also included.

When “TC>TP” (for example, when the user arrives at the waiting point before the allocated vehicle), “TW=TC−TP>0”.

Further, when “TC≤TP” (for example, when the user arrives at the waiting point after the allocated vehicle or when the allocated vehicle and the user arrive at the same time), “TW=0”.

Therefore, the user side waiting time TW can also be calculated by the following equation (3).

TW−Max(TC−TP,0) (3)

According to the equation (3), since it is only necessary to determine the sign of the “TC−TP” in the evaluation of the maximum value function “Max (x, y)”, the calculation cost can be reduced as compared with the calculation of the user side waiting time TW by using the equations (1) and (2).

In addition, assuming that a time during the user is on the allocated vehicle from the waiting point to the destination is “boarding time TR”, a time from when the user makes the vehicle allocation request to when the user arrives at the destination by getting on the allocated vehicle “total time TA” is calculated by the following equation (4) (the equation (2) was used in the transformation of the equation in the middle).

$$TA = TS + TR = TP + TW + TR \qquad ( 4 )$$

The boarding time TR is calculated based on the waiting point and the destination. Therefore, the total time TA can be calculated by determining the waiting point, the vehicle position of the allocated vehicle, the user position, and the destination.

As described above, the time calculation unit 235 calculates the travel time of the user, the waiting time of the user, and the total time, for each combination of the waiting point and the allocated vehicle.

The user characteristic determination unit 237 (user characteristic determination means) determines the user characteristic based on the user attribute information. Specifically, a constraint condition for the travel time and the waiting time requested by the user who created the vehicle allocation request is estimated based on the user attribute information.

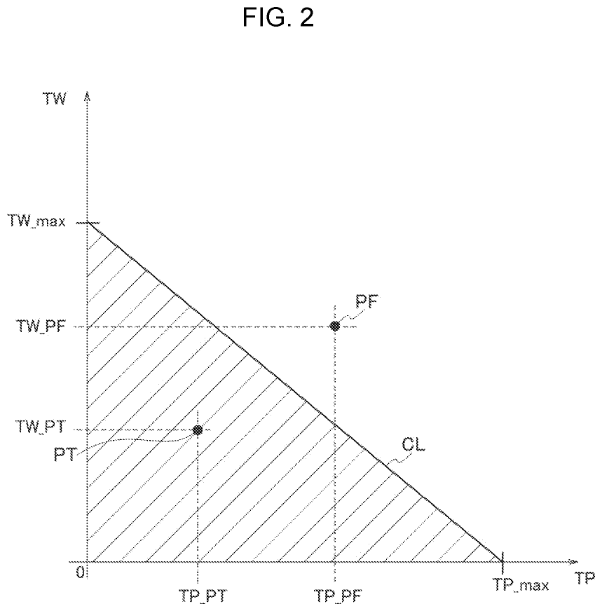

FIG. 2 is a graph showing user characteristic of a user using the vehicle allocation system. The constraint condition for the travel time and the waiting time is represented as shaded area in a coordinate system having two coordinate axes of the user side travel time TP and the user side waiting time TW as shown in FIG. 2.

The shaded area in FIG. 2 is expressed as a set of equations (5-1), (5-2), and (5-3) satisfying all of the equations (TP, TW).

TP/TP_max+TW/TW_max≤1 (5-1)

TW≥0 (5-2)

TP≥0 (5-3)

Here, the value “TP_max” represents the maximum value that the user side travel time TP can take, and the value “TW_max” represents the maximum value that the user side waiting time TW can take.

It is assumed that a calculated travel time of the user is “TP_PF” and a calculated waiting time of the user is “TW_PF” as a result of calculation for a certain combination of the waiting point and the allocated vehicle. Furthermore, it is assumed that the calculated result is plotted as a point PF having coordinates (TP_PF, TW_PF) in the graph of FIG. 2. In this case, since the point PF is not within the shaded area, it can be said that the combination of the waiting point and the allocated vehicle corresponding to the point PF does not satisfy the user characteristic.

On the other hand, it is assumed that a calculated travel time of the user is “TP_PT” and a calculated waiting time of the user is “TW_PT” as a result of calculation for a certain combination of the waiting point and the allocated vehicle. Furthermore, it is assumed that the calculated result is plotted as a point PT having coordinates (TP_PT, TW_PT) in the graph of FIG. 2. In this case, since the point PT is within the shaded area, it can be said that the combination of the waiting point and the allocated vehicle corresponding to the point PT satisfies the user characteristic.

That is, in the case that the travel time of the user and the waiting time of the user calculated for the combination of the waiting point and the allocated vehicle satisfy all the equations (5-1), (5-2), and (5-3), it can be said that the combination of the waiting point and the allocated vehicle satisfies the user characteristic. In other cases, it does not satisfy the user characteristic.

The user's demand for the vehicle allocation system varies from user to user. For example, the user's request may be “a request that the user can wait until the allocated vehicle arrives, but the user does not want to walk to the waiting point at which the user waits for the allocated vehicle” (“request to shorten the travel time”), or conversely, the user's request may be “a request that the user can walk to the waiting point at which the user waits for the allocated vehicle, but the user does not want to wait until the allocated vehicle arrives” (“request to shorten the waiting time”).

As described above, the user's request for the vehicle allocation system includes a trade-off relationship between the travel time of the user and the waiting time of the user.

Therefore, the user characteristic determination unit 237 adjusts the value “TW_max” and the value “TP_max” based on the user attribute information, thereby estimates or corrects the user characteristic used for extracting the waiting point and the allocated vehicle in the vehicle allocation system.

A boundary CL in the first quadrant, which is part of the boundaries of the shaded area in FIG. 2 is defined by a linear function, but is not limited thereto.

For example, the boundary in the first quadrant may be defined by various monotonous decreasing functions such that the user side waiting time TW decreases as the user side travel time TP increases. In this case, the user characteristic determination unit 237 adjusts the parameters that define the shape of the monotonous decrease function based on the user attribute information.

In addition, the user characteristic determination unit 237 may estimate or correct the user characteristic used for extracting the waiting point and the allocated vehicle in the vehicle allocation system based on the environmental information (Information about the environment in which the user resides) or the event type (Event type before and after vehicle allocation request).

Further, the user characteristic determination unit 237 may determine the user characteristic based on an explicit instruction from the user.

The vehicle extraction unit 239 (extraction means) extracts a recommended combination according to the vehicle allocation request, from the combination of the waiting point and the allocated vehicle on the basis of the travel time of the user and the waiting time of the user calculated by the time calculation unit 235.

Specifically, the vehicle extraction unit 239 extracts the combination of the waiting point and the allocated vehicle, the combination satisfying the user characteristic estimated by the user characteristic determination unit 237 as the recommended combination. The user characteristic is the constraint condition for the travel time and the waiting time.

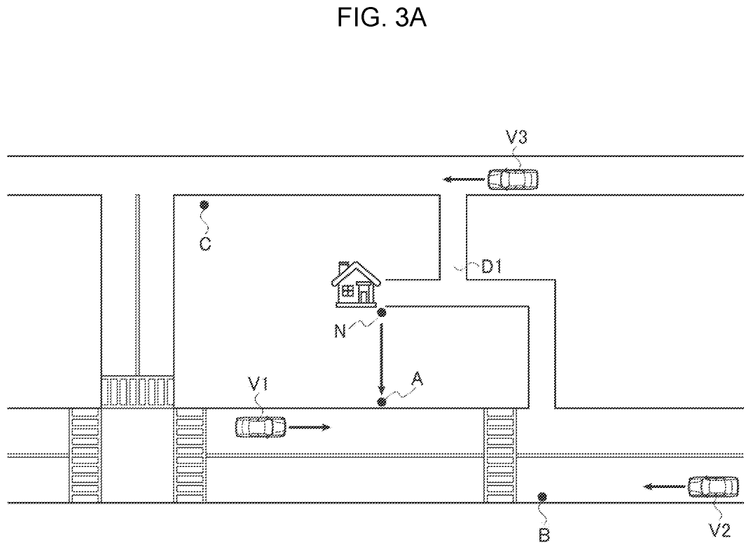

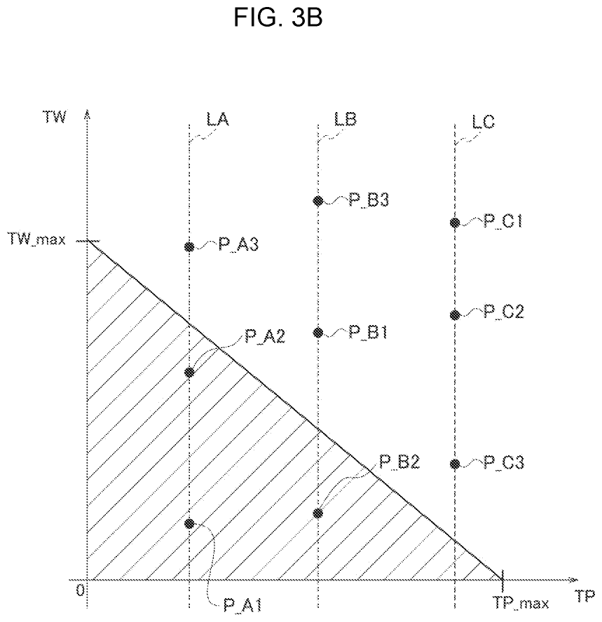

An example of processing in the vehicle extraction unit 239 is explained with reference to FIG. 3A and FIG. 3B. FIG. 3A is a diagram showing an example of the user position, the position of the allocated vehicle, and the waiting point. FIG. 3B is a graph showing a pair of the travel time of the user and the waiting time of the user, calculated in a positional relationship shown in FIG. 3A, the pair plotted in a graph showing the user characteristic.

As shown in FIG. 3A, it is assumed that a waiting point A, a waiting point B, and a waiting point C are registered in the vehicle allocation system, and an allocated vehicle V1, an allocated vehicle V2, and an allocated vehicle V3 are registered in the vehicle allocation system.

It is assumed that a user position at the time of the vehicle allocation request is indicated by a point N, and that a travel time of the user from the point N is increased in the order of the waiting point A, the waiting point B, and the waiting point C.

It is also assumed that a positional relationship between the allocated vehicle V1, the allocated vehicle V2, and the allocated vehicle V3 at the time of the vehicle allocation request is as shown in FIG. 3A. Due to the positional relationship between the waiting points and the allocated vehicles, the arrival time of each allocated vehicle at the waiting point is different. It is assumed that a travel time of each allocated vehicle to the waiting point A is longer in the order of the allocated vehicle V1, the allocated vehicle V2, and the allocated vehicle V3. It is assumed that a travel time to the waiting point B is longer in the order of the allocated vehicle V2, allocated vehicle V1, and the allocated vehicle V3. It is assumed that a travel time to the waiting point C is longer in the order of the allocated vehicle V3, allocated vehicle V2, and the allocated vehicle V1.

In the example of FIG. 3A, since there are three waiting points to be calculated and three allocated vehicles to be calculated, the number of combinations of the waiting points and the allocated vehicles is nine (3×3=9). Therefore, the time calculation unit 235 calculates the times for each combination of all the waiting points and the allocated vehicles.

Then, based on the calculation result, as shown in FIG. 3B, nine points (point P_A1, point P_A2, point P_A3, point P_B1, point P_B2, point P_B3, point P_C1, point P_C2, and point P_C3) are plotted on a graph showing user characteristic.

In FIG. 3B, a combination of a waiting point and an allocated vehicle, corresponding to a point is clearly indicated by an index. (For example, since the index of the point P_A1 is A1, the point P_A1 corresponds to the combination of the waiting point A and the allocated vehicle V1.)

The vehicle extraction unit 239 determines whether or not the plotted points are included in the shaded area indicating the user characteristic, that is, whether or not the calculated pair of the travel time the waiting time satisfies the constraint condition.

Then, the combination of the waiting point and the allocated vehicle corresponding to the pair of the travel time and the waiting time satisfying the constraint condition is extracted as the recommended combination. On the other hand, the combination of the waiting point and the allocated vehicle corresponding to the pair of the travel time and the waiting time that does not satisfy the constraint condition is not extracted as the recommended combination.

In the example shown in FIG. 3B, the combination of the waiting point and the allocated vehicle corresponding to the points P_A1, P_A2, and P_B2 is extracted as the recommended combination. Therefore, three cases are extracted: a case of meeting with the allocated vehicle V1 at the waiting point A, a case of meeting with the allocated vehicle V2 at the waiting point A, and a case of meeting with the allocated vehicle V2 at the waiting point B.

The combination of the waiting point and the allocated vehicle extracted by the vehicle extraction unit 239 may vary depending on the user characteristic estimated by the user characteristic determination unit 237.

In addition, the vehicle extraction unit 239 may give a score (recommended degree) for each recommended combination based on the user characteristic. For example, in the shaded area representing the user characteristic shown in FIG. 2, the closer the point is to the origin, the higher the score is given so that the recommended combinations can be compared with each other.

The recommended combination extracted by the vehicle extraction unit 239 is output to the outside of the allocated vehicle extraction server 200 via the communication unit 210. Then, the output recommended combination is acquired by the communication unit 110 of the allocated vehicle display terminal 100 and is displayed on the display unit 160.

As described above, the allocated vehicle extraction server is configured. For example, the control unit 130 of the allocated vehicle display terminal 100 may be provided with the time calculation unit 235, the user characteristic determination unit 237, and the vehicle extraction unit 239, and thus, the recommended combination may be extracted by the allocated vehicle display terminal 100.

In addition, the user characteristic may be determined by the allocated vehicle display terminal 100, and the recommended combination may be extracted by the allocated vehicle display terminal 100 from the combinations of the waiting point and the allocated vehicle distributed from the allocated vehicle extraction server 200.

### [Process Procedure of Allocated Vehicle Extraction]

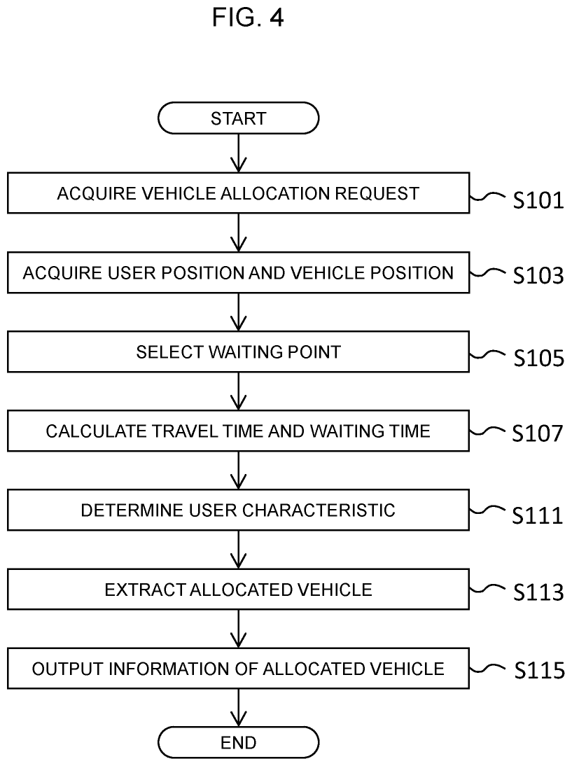

A process procedure of the allocated vehicle extraction according to the present embodiment is explained next with reference to the flowchart of the FIG. 4. The process of the allocated vehicle extraction shown in FIG. 4 is started when the operation of the vehicle allocation system is started and is repeatedly executed while the vehicle allocation system is in the operating state.

In step S101, the allocated vehicle extraction server 200 acquires the vehicle allocation request transmitted from the allocated vehicle display terminal 100 via the communication unit 210.

In step S103, the position information acquisition unit 233 acquires the user position and the vehicle position of the allocated vehicle 300 at the time of the vehicle allocation request via the communication unit 210.

In step S105, the waiting point setting unit 231 selects the waiting point to be calculated by the time calculation unit 235 from the waiting points registered in the vehicle allocation system. Further, among the allocated vehicle 300 registered in the vehicle allocation system, the allocated vehicle to be calculated by the time calculation unit 235 is selected.

In step S107, the time calculation unit 235 calculates the travel time of the user from the user position to the waiting point, and the waiting time of the user obtained by subtracting the travel time of the user from the time from making the vehicle allocation request by the user to getting on the allocated vehicle.

In step S111, the user characteristic determination unit 237 determines the user characteristic based on the user attribute information. At that time, the user characteristic used for extracting the waiting point and the allocated vehicle in the vehicle allocation system are estimated or corrected based on the user attribute information and the environmental information.

In step S113, the vehicle extraction unit 239 extracts the recommended combination corresponding to the vehicle allocation request from the combination of the waiting point and the allocated vehicle based on the travel time of the user and the waiting time of the user calculated by the time calculation unit 235.

In step S115, the recommended combination extracted by the vehicle extraction unit 239 is output to the outside of the allocated vehicle extraction server 200 via the communication unit 210.

### [Example of Estimation/Correction of User Characteristic]

An example of estimation/correction of user characteristic performed by the user characteristic determination unit 237 is explained.

The user's demand for the vehicle allocation system varies from user to user. Therefore, it is necessary to estimate and correct the user characteristic used for extracting the waiting point and the allocated vehicle in the vehicle allocation system according to the user. In addition, the user's request varies depending on the environment in which the user resides and the presence/absence of schedule and type of schedule before and after the vehicle allocation request. Therefore, it is necessary to estimate and correct according to the environmental information and event type.

Therefore, the user characteristic determination unit 237 estimates and corrects the user characteristic based on the “user attribute information”, the “environmental information”, and the “event type”.

First, estimation/correction of the user characteristic based on the “user attribute information” is explained.

For example, wheelchair users, the elderly person, children, private vehicle owners, managers, etc. tend to make “a request that the user can wait until the allocated vehicle arrives, but the user does not want to move to the waiting point at which the user waits for the allocated vehicle” (“request to shorten the travel time”). In addition, office workers, athletes, students, housewives, etc. tend to make “a request that the user can move to the waiting point at which the user waits for the allocated vehicle, but the user does not want to wait until the allocated vehicle arrives” (“request to shorten the waiting time”).

Therefore, the user characteristic determination unit 237 estimates whether the user has a tendency to make the “request to shorten the travel time” or the “request to shorten the waiting time”, based on the preference, age, sex, occupation, physical characteristics, etc., of the user among the user attribute information.

More specifically, when the information of “occupation” can be obtained in the user attribute information, if the occupation is, for example, a student (physically strong), a sports personnel, office workers (sales), the user characteristic determination unit 237 estimates that the user tends to make the “request to shorten the waiting time”. On the other hand, if the occupation is, for example, a monk (basically difficult to walk in Japanese clothes) or an office worker (office work), the user characteristic determination unit 237 estimates that the user tends to make the “request to shorten the travel time”.

When the information of “age” can be obtained in the user attribute information, for example, if it is determined that the user is in teens to 40s based on “age”, it is assumed that the user has confidence in his/her physical strength and walking, and thus, the user characteristic determination unit 237 estimates that the user tends to make the “request to shorten the waiting time”. On the other hand, if it is determined that the user is under teens or after 50s, the user characteristic determination unit 237 estimates that the user tends to make the “request to shorten the travel time”.

When the information of “physical characteristics” can be obtained in the user attribute information (for example, when it can be acquired by linking with a health application such as a walking application), the user characteristic determination unit 237 estimates that a person who has a large amount of daily walking distance or activity tends to make the “request to shorten the waiting time”. On the other hand, the user characteristic determination unit 237 estimates that users of wheelchairs and canes, and a person who has a small amount of daily walking distance or activity tends to make the “request to shorten the travel time”.

If the type of the user is determined to be “impatience” based on the user attribute information, the user characteristic determination unit 237 estimates that the user tends to make the “request to shorten the waiting time”. On the other hand, if the type of the user is determined to be “carefree” (being lazy or having no sense of direction), the user characteristic determination unit 237 estimates that the user tends to make the “request to shorten the travel time”. The type of “impatience” or “carefree” may be determined based on the user's reservation history, vehicle allocation history, or a prior questionnaire to the user.

In this way, the user characteristic determination unit 237 estimates which tendency of the user is closer to make the “request to shorten the travel time” or to make the “request to shorten the waiting time”.

If the tendency of the user is closer to make the “request to shorten the travel time”, the user characteristic determination unit 237 adjusts the value “TP_max” that defines the boundary CL of FIG. 2 to be smaller than the default value.

If the tendency of the user is closer to make the “request to shorten the waiting time”, the user characteristic determination unit 237 adjusts the value “TW_max” that defines the boundary CL of FIG. 2 to be smaller than the default value.

The extent to which the boundary CL is adjusted in comparison with the default value may be changed according to the strength of required level related to the tendency of the user.

Thus, by adjusting a value “TW_max” or a value “TP_max” on the basis of the user attribute information, the user characteristic determination unit 237 estimates or corrects the user characteristic used for extracting the waiting point and the allocated vehicle in the vehicle allocation system.

Second, estimation/correction of the user characteristic based on the “environmental information” is explained.

For example, in the case of a clear and warm climate, the user does not feel a great burden in walking to the waiting point, but in the case where the temperature is far from the temperature at which the human feels comfortable, where it is raining or snowing, or where the wind is strong, the user tends to feel a great burden in walking to the waiting point.

Thus, the user characteristic determination unit 237 estimates whether the user has a tendency to make the “request to shorten the travel time” or the “request to shorten the waiting time”, based on the environmental information.

In the above example, the user characteristic determination unit 237 estimates that the user has a tendency to make the “request to shorten the travel time”, in the case that the temperature is far from the comfortable temperature, in the case that it is raining or snowing, or in the case that the wind is strong.

Then, the user characteristic determination unit 237 adjusts the boundary CL similarly to the estimation/correction of the user characteristic based on the “user attribute information”.

Third, estimation/correction of the user characteristic based on the “event type” is explained.

For example, the tendency of the user can be estimated from the calendar information of the user and a departure point and a destination point of the user after using the vehicle allocation service.

Specifically, it is assumed that it is determined that the schedule after using the vehicle allocation service is “live concert”, “children's athletic meet”, “entertainment golf”, “travel”, or “medical examination at a hospital”. In this case, since it is considered that the user acts with priority on preserving physical strength, the user characteristic determination unit 237 estimates that the user is likely to make the “request to shorten the travel time”.

On the other hand, it is assumed that it is determined that the schedule after using the vehicle allocation service is “sales visit” or “arrival at work”. In this case, since the user is considered to be conscious of time, the user characteristic determination unit 237 estimates that the user is likely to make the “request to shorten the waiting time”. In addition, in the case that the departure point for using the vehicle allocation service is a “customer destination” or like, since it is difficult to stay at the departure point for a long time, the user characteristic determination unit 237 estimates that the user is likely to make the “request to shorten the waiting time”.

Thus, the event type is determined from the calendar information of the user and/or the departure and destination of the user, and the user characteristic determination unit 237 estimates/corrects the user characteristic according to the tendency of the user corresponding to the event type. The user characteristic determination unit 237 adjusts the boundary CL similarly to the estimation/correction of the user characteristic based on the “user attribute information”.

Various variations are possible in the estimation/correction of the user characteristics performed by the user characteristic determination unit 237, and the present invention is not limited to the above-described example.

### [Effect of Embodiment]

As explained in detail above, the allocated vehicle extraction server, the allocated vehicle extraction means, the allocated vehicle extraction method, and the allocated vehicle display terminal according to the present embodiment acquire the vehicle allocation request from the operation terminal on which the user performs a request operation, acquire the user position and the vehicle position of the allocated vehicle at the time of the vehicle allocation request, calculate the travel time of the user from the user position to the waiting point at which the user waits for the allocated vehicle, and the waiting time of the user obtained by subtracting the travel time of the user from the time from making the vehicle allocation request by the user to getting on the allocated vehicle, and extract the allocated vehicle based on the travel time and the waiting time.

That is, since the allocated vehicle is extracted based on the travel time of the user to the waiting point at which the user waits for the allocated vehicle, and the waiting time of the user, the convenience of the user using the vehicle allocation system can be improved. In particular, even when the user position and the vehicle position of the allocated vehicle are dynamically changed, the allocated vehicle according to the vehicle allocation request can be proposed to the user in response to the dynamically changed situation.

Further, the allocated vehicle can be extracted in consideration of the trade-off relation between the travel time of the user and the waiting time of the user in the request from the user, and the convenience of the user using the vehicle allocation system can be improved.

The allocated vehicle extraction server, the allocated vehicle extraction means, the allocated vehicle extraction method, and the allocated vehicle display terminal according to the present embodiment may calculate the travel time and the waiting time for each combination of the waiting point and the allocated vehicle, and may extract the recommended combination from the combination on the basis of the travel time and the waiting time. Thus, even when the user position and the vehicle position of the allocated vehicle are dynamically changed, the waiting point and the allocated vehicle according to the vehicle allocation request can be proposed to the user in response to the dynamically changed situation. Further, the waiting point and the allocated vehicle can be extracted in consideration of the trade-off relation between the travel time of the user and the waiting time of the user in the request from the user, and the convenience of the user using the vehicle allocation system can be improved.

The allocated vehicle extraction server, the allocated vehicle extraction means, the allocated vehicle extraction method, and the allocated vehicle display terminal according to the present embodiment may estimate the constraint condition for the travel time and the waiting time based on the attribute information, and may extract the combination satisfying the constraint condition as the recommended combination. Thus, the user characteristic variously different by the user can be reflected on the extraction result of the waiting point and the allocated vehicle, and the vehicle allocation service customized for each user can be provided.

The allocated vehicle extraction server, the allocated vehicle extraction means, the allocated vehicle extraction method, and the allocated vehicle display terminal according to the present embodiment may acquire the environmental information about surroundings of the user position and may correct the constraint condition based on the environmental information. Thus, the difference in the surrounding environment of the user can be reflected on the extraction result of the waiting point and the allocated vehicle, and the vehicle allocation service customized for each user can be provided.

The allocated vehicle extraction server, the allocated vehicle extraction means, the allocated vehicle extraction method, and the allocated vehicle display terminal according to the present embodiment may output and/or display information of the recommended combination. Thus, the waiting point and the allocated vehicle extracted in accordance with the vehicle allocation request can be presented for not only the user but also the servicer providing the vehicle allocation service, and the convenience of the user using the vehicle allocation system can be improved.

The allocated vehicle extraction server, the allocated vehicle extraction means, the allocated vehicle extraction method, and the allocated vehicle display terminal according to the present embodiment may set a value obtained by subtracting the travel time from the time required for the allocated vehicle to move from the vehicle position to the waiting point as the waiting time when the value is 0 or more. Thus, the waiting time of the user can be calculated by a simple method, and the calculation cost can be reduced.

The allocated vehicle extraction server, the allocated vehicle extraction means, the allocated vehicle extraction method, and the allocated vehicle display terminal according to the present embodiment may acquire the user position from the operation terminal. Thus, the allocated vehicle according to the vehicle allocation request can be proposed to the user based on the accurate position of the user.

The allocated vehicle extraction server, the allocated vehicle extraction means, the allocated vehicle extraction method, and the allocated vehicle display terminal according to the present embodiment may use a portable terminal as the operation terminal. It is possible to accurately evaluate the user position based on position information of the portable terminal held by the user, and the allocated vehicle according to the vehicle allocation request can be proposed to the user based on the accurate user position.

Although the contents of the present invention have been described above with reference to the embodiment, the present invention is not limited to these descriptions, and it will be apparent to those skilled in the art that various modifications and improvements can be made. It should not be construed that the present invention is limited to the descriptions and the drawings that constitute a part of the present disclosure. On the basis of the present disclosure, various alternative embodiments, practical examples, and operating techniques will be apparent to those skilled in the art.

In is needless to mention that the present invention also includes various embodiments that are not described herein. Therefore, the technical scope of the present invention is to be defined only by the invention specifying matters according to the scope of claims appropriately obtained from the above descriptions.

Respective functions described in the above embodiment may be implemented by one or plural processing circuits. The processing circuits include programmed processing devices such as a processing device including an electric circuit. The processing devices also include devices such as an application specific integrated circuit (ASIC) and conventional circuit elements that are arranged to execute the functions described in the embodiment.

### REFERENCE SIGNS LIST

100 allocated vehicle display terminal
110 communication unit
130 control unit
150 sensor
160 display unit
170 operation unit
200 allocated vehicle extraction server
210 communication unit
220 database
230 control unit
231 waiting point setting unit
233 position information acquisition unit
235 time calculation unit
237 user characteristic determination unit
239 vehicle extraction unit
300 allocated vehicle
400 network

1. An allocated vehicle extraction server comprising
a communication unit which acquires a vehicle allocation request including an attribute information of the user from an operation terminal on which a user performs a request operation, and acquires a user position and a vehicle position of an allocated vehicle at the time of the vehicle allocation request, and
a controller which processes the vehicle allocation request,
wherein the controller
calculates, for each combination of a waiting point and the allocated vehicle,
a user side travel time of the user required for the user to move to the waiting point, and
a waiting time of the user obtained based on a vehicle side travel time required for the allocated vehicle to move to the waiting point and the user side travel time,
estimates a constraint condition based on the attribute information, and
extracts a recommended combination satisfying the constraint condition from the combination on the basis of the user side travel time and the waiting time.

2. The allocated vehicle extraction server according to claim 1,
wherein the constraint condition represents a trade-off relationship between the user side travel time and the waiting time.

3. The allocated vehicle extraction server according to claim 1, wherein
the constraint condition is a condition that the user side travel time does not exceed an upper limit value represented by a function of the waiting time and which decreases monotonically with an increase of the waiting time.

4. The allocated vehicle extraction server according to claim 1,
wherein the controller
acquires an environmental information about surroundings of the user position and corrects the constraint condition based on the environmental information.

5. (canceled)

6. (canceled)

7. The allocated vehicle extraction server according to claim 1, wherein
the constraint condition is represented by a set of equations:
TP/TP_max+TW/TW_max≤1, TW≥0, and TP≥0,
where TP represent the user side travel time, TP_max represents a maximum value that the user side travel time can take, TW represent the waiting time, and TW_max represents a maximum value that the waiting time can take.

8. The allocated vehicle extraction server according to claim 1, wherein
the controller outputs information of the recommended combination via the communication unit to an outside of the allocated vehicle extraction server.

9. An allocated vehicle extraction means comprising
a communication means which acquires a vehicle allocation request including an attribute information of the user from an operation terminal on which a user performs a request operation, and acquires a user position and a vehicle position of an allocated vehicle at the time of the vehicle allocation request,
a time calculation means which calculates, for each combination of a waiting point and the allocated vehicle,
a user side travel time of the user required for the user to move to the waiting point, and
a waiting time of the user obtained based on a vehicle side travel time required for the allocated vehicle to move to the waiting point and the user side travel time,
a user characteristic determination means which estimates a constraint condition based on the attribute information, and
an extraction means which extracts a recommended combination satisfying the constraint condition from the combination on the basis of the user side travel time and the waiting time.

10. An allocated vehicle extraction method comprising
acquiring a vehicle allocation request including an attribute information of the user from an operation terminal on which a user performs a request operation,
acquiring a user position and a vehicle position of an allocated vehicle at the time of the vehicle allocation request,
calculating, for each combination of a waiting point and the allocated vehicle,
a user side travel time of the user required for the user to move to the waiting point, and
a waiting time of the user obtained based on a vehicle side travel time required for the allocated vehicle to move to the waiting point and the user side travel time,
estimating a constraint condition based on the attribute information, and
extracting a recommended combination satisfying the constraint condition from the combination on the basis of the user side travel time and the waiting time.

11. An allocated vehicle display terminal comprising
an operation unit which receives a vehicle allocation request of a user,
a communication unit which sends a user position at the time of the vehicle allocation request and receives a recommended allocated vehicle extracted from an allocated vehicle,
a display unit which displays the recommended allocated vehicle, wherein
the vehicle allocation request includes an attribute information of the user,
after a user side travel time of the user required for the user to move to a waiting point, and a waiting time of the user obtained based on a vehicle side travel time required for the allocated vehicle to move to the waiting point and the user side travel time, are calculated, for each combination of the waiting point and the allocated vehicle, and a constraint condition is estimated based on the attribute information,
the recommended allocated vehicle is a vehicle of a recommended combination satisfying the constraint condition extracted from the combination on the basis of the user side travel time and the waiting time.

12. The allocated vehicle extraction server according to claim 1, wherein
the controller sets a value obtained by subtracting the user side travel time from the time required for the allocated vehicle to move from the vehicle position to the waiting point as the waiting time when the value is 0 or more.

13. The allocated vehicle extraction server according to claim 1, wherein
the communication unit acquires the user position from the operation terminal.

14. The allocated vehicle extraction server according to claim 1, wherein
the operation terminal is a portable terminal.
